(19) United States
(12) Patent Application Publication
(10) Pub. No.: US 2006/0123858 A1
(43) Pub. Date: Jun. 15, 2006

(54) Anti-theft device for case

(76) Inventor: Bruno Bouan, La Varenne Saint Hilaire (FR)

Correspondence Address: BACHMAN & LAPOINTE, P.C., 900 CHAPEL STREET, SUITE 1201, NEW HAVEN, CT, 06510, US

(21) Appl. No.: 10/555,536

(22) PCT Filed: May 4, 2004
(86) PCT No.: PCT/FR04/01072

§ 371 Date: Jan. 17, 2006

(30) Foreign Application Priority Data
May 5, 2003 (FR) 03/05454

(51) Int. Cl. E05B 65/00

(52) U.S. Cl. 70/57.1

(57) ABSTRACT

An anti-theft device consists of a case comprising two large faces and four sides. One of the large faces forms an opening for the insertion of an article having dimensions that are essentially equal to those of the case. The opening face comprises a rim. The invention is characterized in that it comprises: a trigger member which can occupy a locked position and which can move in translation in the axis of the plane of the opening face which trigger member comprises at least one rim which co-operates with the above-mentioned rim in order to prevent the article from being extracted from the case and a locking pull tab which can move along an axis that is transverse to the movement of the trigger member and which can lock the trigger member in the locked position thereof.

### BACKGROUND OF THE INVENTION

(1) Field of the Invention

This invention relates to a device for an anti-theft case. It is applicable, particularly but not exclusively, to cases intended to house cassettes, CDs or DVDs.

(2) Prior Art

The general principles of such cases are well known. They generally comprise a mobile trigger member that prevents the protected article from being removed when in locked position, the trigger member being held in locked position by a system that is able to interact with a magnetic unlocking tool.

The trigger member is positioned in its resting position so as to partially block the slot for inserting the article, or to prevent the opening of an access trap or of the cover of the case, or even to block a case that contains two rotating parts.

Patent application WO 9836997 describes an anti-theft case that is also known in the state of the art. It describes a plastic case that enables the storage and presentation of a rectangular article, provided with a small compartment and a large compartment. The large compartment has an access opening that enables the insertion of the article in the compartment and its removal. The small compartment works as a lockable compartment in which a blocking plate is mounted so as to slide and to be selectively mobile in a part of the access opening so as to retain and release the article in the large compartment. Lockable levers that can be unlocked magnetically fit onto the protuberances of the blocking plate when the latter is in its locked position. Elastic arms maintain the lockable levers in their locked position until they are diverted using a key.

Such a device proves not to be entirely satisfactory. In fact, the small compartment, designed to block the opening of the large compartment that makes up the housing of the case when the article is placed inside it, is a relatively complex independent element, and thus entails a considerable additional cost compared to the cost of the large compartment that forms the case. Furthermore, this small compartment also has a locking element that is mobile around a circular axis; this locking element is relatively fragile and not very reliable for efficiently locking the position in which the case contains an article. Finally, this device has the drawback of being very large, due to the dimensions of the small compartment added onto the dimensions of the case, which requires more space on the shelves of the shop.

U.S. Pat. No. 5,850,752 is also known, which describes an anti-theft case made up of two complementary parts. The bottom part is supported on one side by a shoulder and on the other side by a locking mechanism. When unlocking, the bottom part can be tilted and then removed from the complementary part so as to allow the contents to be removed through the slot thus opened.

This solution is not satisfactory, since placing and removing the bottom part requires operations that are not very compatible with quick handling by operators with little experience.

### SUMMARY OF THE INVENTION

The aim of this invention is to solve the disadvantages of the devices of the previous technique by providing a new anti-theft device that is particularly advantageous.

For this purpose, the invention relates to an anti-theft device for articles, comprising a parallelepipedal rigid case consisting of two large faces and four sides, one of the large faces forming an opening for the insertion of an article with dimensions that are essentially the same as those of the case, the said opening face comprising a raised edge, which is an extension of one of the aforementioned sides, characterised in that it comprises:

a trigger member that can occupy a locked position, which is mobile in translation around the axis of the plane of the opening face, the said trigger member comprising at least one raised edge, the said raised edge cooperating with the aforementioned raised edge so as to prevent the removal of the article contained in the case,

a locking pull rod that is mobile around an axis that is transversal to the movement of the trigger member and which can lock the aforementioned trigger member in its locked position.

Advantageously, the aforementioned trigger member comprises at least one counterweight, or a strip, consisting of at least one magnet-sensitive element, such as iron, that is able to interact with a magnetic field.

Furthermore, the pull rod comprises at least one housing or one orifice that is able to house or receive the aforementioned counterweight when the trigger member is in its locked position.

According to a possibility offered by the invention, the counterweight can have a top section that is essentially T-shaped so as to interact with a part of the housing or the orifice by detenting.

Advantageously, the device may comprise at least one spring located under the counterweight in order to raise the said counterweight inside the housing or the orifice of the pull rod.

Advantageously, the case, the trigger member and/or the pull rod are made from a plastic material, for example a polycarbonate.

According to an advantageous aspect of the invention, the trigger member comprises at least one mobile lateral wing, at least one part of which is housed in a housing of the case so that, when the trigger member moves, this part becomes trapped in the said housing and defines the translation movement of the said trigger member.

Advantageously, the trigger member comprises at least one orifice for the pushing end of the pull rod to pass through. Preferably, the aforementioned orifice will have a shape that is essentially identical to the shape of the pushing end of the pull rod.

Advantageously, the trigger member may comprise a second orifice for the other end of the pull rod to pass through, when the trigger member is in its locked position. Preferably, the second orifice will have a shape that is essentially identical to the shape of the end of the pull rod.

According to an advantageous aspect of the invention, the other large face of the case may comprise an orifice or an opening.

Advantageously, the trigger member comprises at least one spring that can push the pull rod back when the trigger member is unlocked.

According to a possibility offered by the invention, the aforementioned case may comprise means for wedging the article, the said wedging means being removable and mobile, if necessary.

In an alternative embodiment, the case may comprise a mobile ring that can fit tightly around the article housed in the case.

In another alternative embodiment, the case may comprise a lid.

Thanks to these characteristics, the invention thus provides an anti-theft device equipping a case containing an article, which is both easy to use and mechanically resistant, while considerably reducing the overall manufacturing cost. Moreover, this invention provides an anti-theft device with dimensions that are identical to those of the case, and therefore very close to those of the article it contains, which implies a size reduction compared with the systems of the previous technique.

### BRIEF DESCRIPTION OF THE DRAWINGS

A preferred embodiment of the invention will be described below, as a non-exhaustive example, in reference to the appended figures, in which:

FIG. 1 shows a schematic view of the anti-theft device according to the invention, in locked position;

FIG. 2 shows a schematic view of the device of the invention, in unlocked position, and a partial view of an article to be inserted in the device;

FIG. 3 shows a schematic view of the article being inserted in the device according to the invention;

FIG. 4 shows a schematic view of the article housed in the case according to the invention when the latter is in its locked position;

FIG. 5 shows the anti-theft device with an article housed in the case, with the trigger member in the unlocked position;

FIG. 6 shows a schematic section view along a plane parallel to the plane of the two large faces of the case shown in FIG. 2 or 3, the trigger member being pushed back into its bottom position;

FIG. 7 shows a schematic section view along a plane parallel to the plane of the two large faces of the case shown in FIG. 4;

FIG. 8 shows a perspective view of the part of the case that comprises the pushing end of the pull rod;

FIG. 9 shows the empty case, the trigger member in released position, with the case in this alternative embodiment comprising a ring designed to fit tightly around the housed article;

FIG. 10 shows the article housed in the case in the alternative embodiment of the case shown in FIG. 9.

### DETAILED DESCRIPTION OF THE PREFERRED EMBODIMENT(S)

The case 1 is made up of a parallelepipedal frame made from a plastic material and opening by means of an opening 2 for insertion of an article 3 such as a compact disc or a cassette, this opening being made in one of the two large parallel faces 4, 5 of the said case 1.

Three 6, 6′, 6″ of the four small sides that surround the two large faces 4, 5 of the case 1 are enclosed by the plastic material that forms the said case 1. A fourth small side 7, ideally one of the two small sides that extend along the length of the large parallel faces 4, 5, is provided with the trigger member 8 as well as the pull rod 9.

The trigger member 8 is fixed to the case 1 by attaching a housing 10, an orifice or a groove on the ends of the two adjoining small sides 6′, 6″ to the aforementioned small side 7 comprising the said trigger member 8 with the pull rod 9. In fact, the trigger member 8 comprises at least one orifice 11, with a shape and size that are the same as the pushing end 12 of the pull rod 9, and the insertion of the pull rod 9 prevents the trigger member 8, during its translation into the unlocked position, from coming completely loose from the case 1. In other words, the trigger member 8 always remains fixed to the case 1, whether separated from it or not.

The trigger member 8 can be blocked by the mechanism for locking it in the closed position, in which it partially covers the large opening face 4. When the locking mechanism is in its unlocked position, the trigger member can move by translation around a translation axis parallel to an axis that matches the intersection between a side face 6′, 6″ and a large face 4, 5. It therefore moves away from the top transverse face 6 and releases the opening face 4.

This movement is guided by lateral means so that, during its movement, the trigger member 8 remains parallel to the opposite face 6 and perpendicular to the side faces 6′, 6″.

If necessary, the trigger member can tilt around a transverse axis, while remaining perpendicular to the side faces 6′, 6″.

The large opening face 4 of the case 1, through which the article 3 is inserted, comprises a raised edge 13 situated opposite the trigger member 8 and forming an extension of the small side 6 opposite the side 7 that comprises the said trigger member 8. This raised edge 13 has a width 11 and a length L1 that are ideally the same as the length of the two large parallel faces.

In an alternative embodiment of the invention, it is possible to provide a lid, not shown in the figures, as a complement to the raised edge 13 of the opening 2, which can close the said opening 2. This lid makes it possible, if necessary, in a specific embodiment of the invention, to do away with the use of the raised edge 13.

Furthermore, the trigger member 8 comprises a raised edge 14 with a width 12 and a length L2, that is ideally the same as the length of the two large parallel faces 4, 5. Thus, when the article 3 is inserted through the opening face 4 into the case 1, and the trigger member 8 is in the locked position, the opening is thus defined, or delimited, by the two raised edges 13, 14, with respective widths 11 and 12. The opening, in the locked position of the trigger member 8, has a width Lₒ that is smaller than the width of the article 3 housed in the case 1 so that the said article 3 can no longer be removed from the case 1.

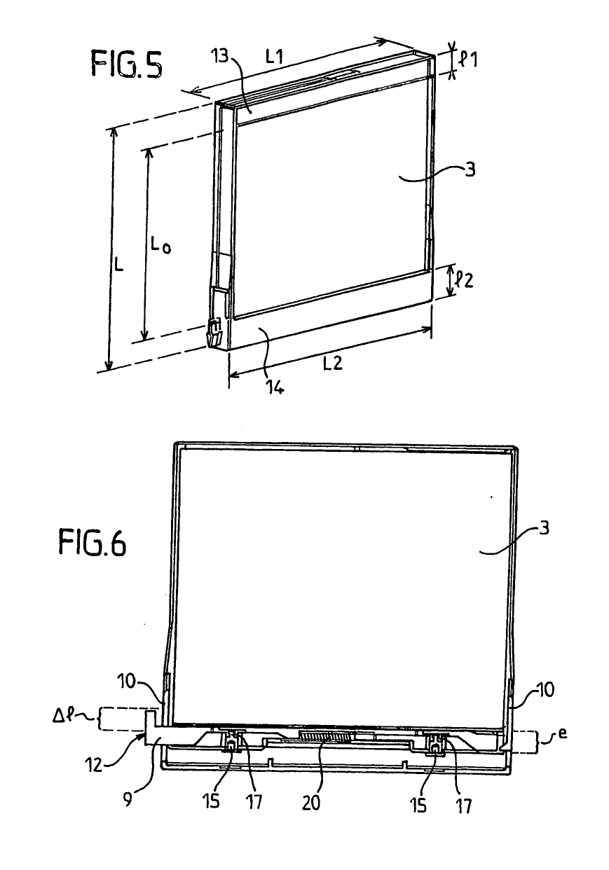

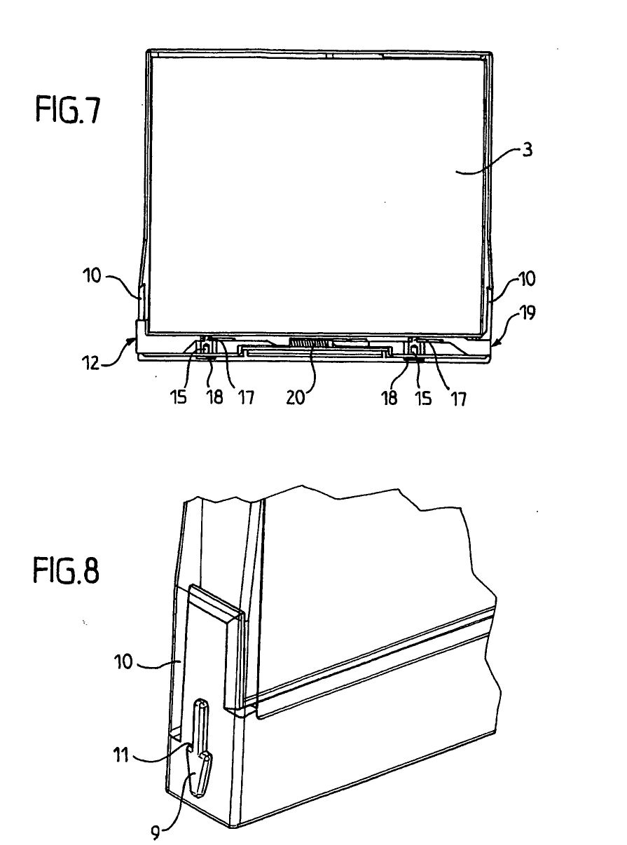

Furthermore, the anti-theft device according to the invention has, in its small side 7, a bottom part that houses the pull rod 9 and the counterweight or counterweights 15, or the strip, which has a width e. In the example selected to illustrate the invention, this width e is essentially the width, which can be considered to be the length if necessary, of the translation movement of the trigger member 8. However, in general terms, the movement of the trigger member 8 is equal to the distance Δ1, shown in FIG. 6, which can have any value whatsoever, depending on the construction of the case 1. The case 1 of the invention has an overall width L and a small width e. The opening width Lₒ of the large opening face 4 is therefore equal, in the locked position of the trigger member 8, to:
Lₒ=L−(l1+l2),

Where: l1 is the width of the raised edge 13, and l2 is the width of the raised edge 14.

When the trigger member 8 is in its unlocked position, the opening Lₒ of the large opening face 4 is defined according to the following relation:
Lₒ=(L+Δ1)−(l1+l2)

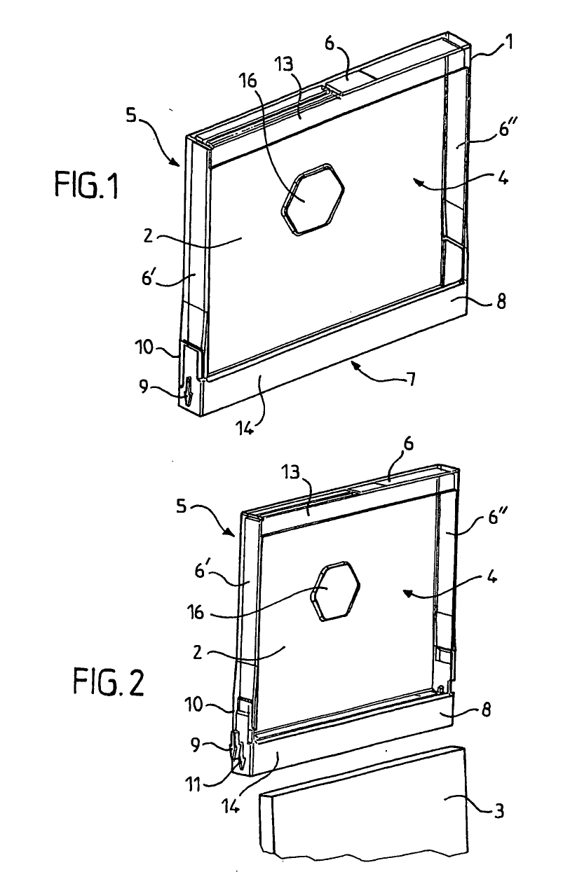

As shown in FIG. 1, the device according to the invention is shown in its locked position, and no article 3 is housed in the said case 1. An orifice 16 is made in the large face 5 opposite the large opening face 4, this orifice 15 having any shape, but obviously being smaller than the dimensions of the article 3 housed in the case 1. In the example selected to illustrate the invention, this orifice 16 is presented in an essentially cylindrical or hexagonal shape.

To open the anti-theft device, the user must use a magnet or a similar device, pressing it against the pushing end 12 of the pull rod 9. In fact, to define an unlocking sequence, the user must initially press against the pushing end 12 of the pull rod 9 and then bring the trigger member 8 up against at least one magnet in order for each counterweight 15 to move into its unlocked position. It can be seen below that the device according to the invention can comprise a plurality of counterweights 15, ideally at least two. Working in this way, the pull rod 9 no longer blocks the trigger member 8 in its locked position, and the said trigger member can be pulled in a translation movement to be separated from the case 1, for example by a distance comprised between 5 and 15 millimetres. Thus, the opening of the large opening face 4 is enlarged, allowing an article to be inserted; the opening in this configuration having a greater width, ideally slightly greater by several millimetres, i.e. between 2 and 5 millimetres, than the width of the article 3 to be protected.

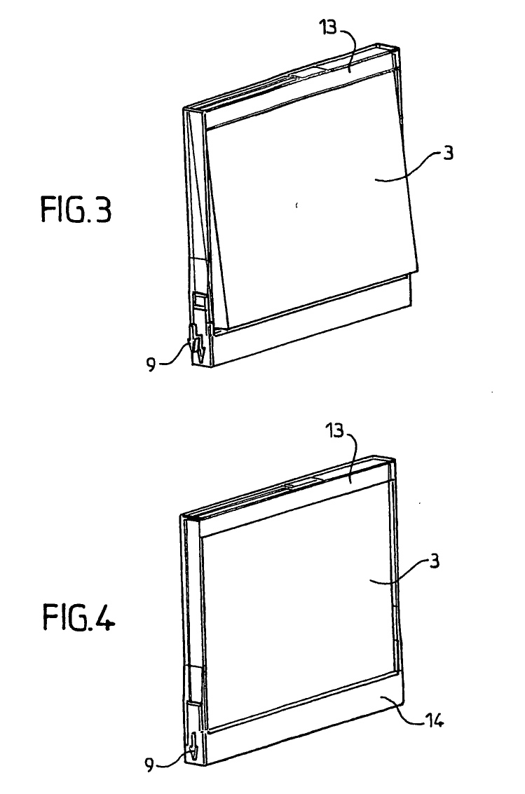

FIG. 3 shows the article, in this case a CD-ROM, being inserted in the housing of the case 1. Once the article 3 is housed in the housing of the case 1, the user pushes the trigger member 8 back against the case 1, the trigger member 8 then being fully pushed into the housing 10, with the grooves or orifices on the small sides 6′, 6″ adjoining the small side 7 that comprises the said trigger member 8. The user then pushes the pushing end 12 of the pull rod 9 so that the latter makes a translation movement perpendicular to the movement of the trigger member 8, this operation making it possible to place the orifice or orifices 17 or housings on the pull rod 9 opposite the counterweights 15, the latter then being made, under the action of springs 18 placed under the said counterweights 15, to penetrate in the said orifice or orifices 17 or housings so as to block the pull rod 9, which in turn blocks the trigger member 8 in its locked position.

According to a possibility offered by the invention and shown in the example selected to illustrate the invention, the trigger member 8 also comprises an orifice 19 situated opposite the orifice 11 made for the pushing end 12 of the pull rod 9. This second orifice 19 has the function of allowing the insertion of the other end of the pull rod 9 when the latter is in the blocked position of the trigger member 8.

Furthermore, in the embodiment of the invention used as an example of the device according to the invention, the case 1 is equipped with two housings 10 situated respectively on either end of the two small sides 6′, 6″ adjoining the side 7 that comprises the trigger member 8. In this way, with a simple construction, the trigger member 8 is held fixed to the case 1 and the translation movement of the trigger member 8 is carried out in a particularly easy manner since the two housings 10 ensure that the trigger member 8 is held in place and guided during the translation movement.

To unlock the anti-theft device of the invention, the user brings the bottom face of the trigger member 8 up against an external device, not shown in the figures, that contains at least one magnet. This magnet acts on the aforementioned counterweights 15 to attract them. At the same time, the user presses the pushing end 12 of the pull rod 9 again so as to slightly release the counterweight or counterweights 15 sideways from the orifice 17 or the housing in which they were inserted. A spring 20 is provided at the level of the pull rod 9 in order to push the latter back when the counterweights are withdrawn and no longer block the said pull rod 9. In order to provide particularly effective blocking of each counterweight 15 in an orifice 17 or a housing, the counterweight has a top section with a specific geometry so as to enable this top section to detent with at least a part of the said orifice or the said housing.

Once the anti-theft device has been unlocked, the user can remove the article 3 housed in the case 1. In order to make it easier to remove this article 3, an orifice 16 is provided on the large face 5 opposite to the opening face 4. Thus, the user can push the article 3 out of the case 1 exerting a pressure through this orifice 16.

In order to lock the anti-theft device, the user only needs to exert a pressure or a force on the pushing end 12 of the pull rod 9. The counterweights 15 are then placed opposite the orifices 17 and penetrate them at least partially, ideally the top part of a counterweight 15, under the effect of the springs 18.

After this, the trigger member 8 comprising at least one spring 20 which can push the pull rod 9 back when the trigger member 8 is in the unlocked position, the said pull rod 9 is pushed back into the outermost position of the trigger member 8.

In the event that the case of the invention is used, particularly, when the article to house is a DVD, it may be desirable to reduce the size allocated inside the case. In fact, the case according to the invention is designed for use with all kinds of articles, regardless of their size, which often depends on the packaging of the actual article.

Consequently, the following three solutions are provided:

removable, mobile wedging means, not shown in the appended figures, for example that can be snapped into place inside the case 1, ideally on its edge or its top side 6, with dimensions that are adapted to the article 3 to be housed inside the case 1 so that the article 3 only has a minimum free play inside the case 1. These mobile wedging means can, if necessary, be adapted to the width of the article to be protected, by means of a simple translation movement in the direction of the width of the said article, once the latter is inserted in the case 1.

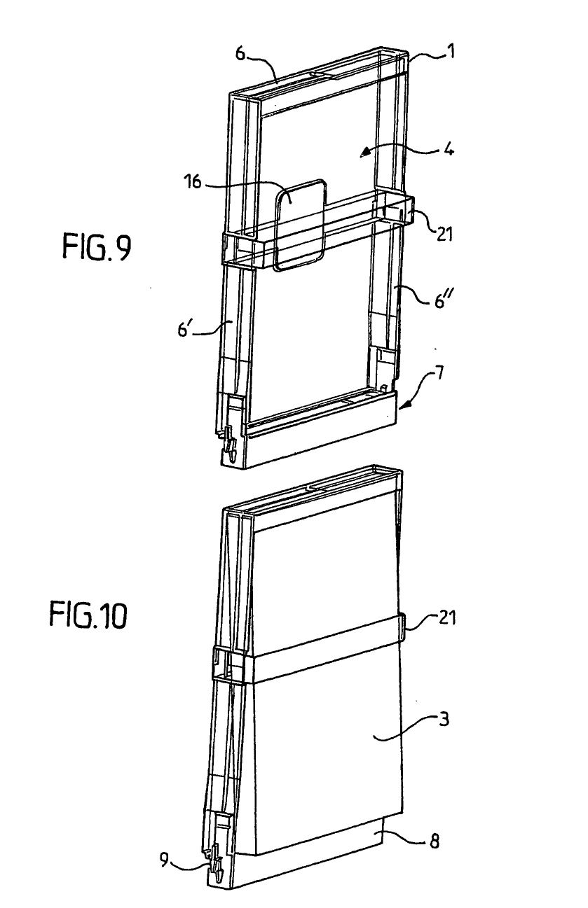

a ring 21 mounted on the case 1, as shown in FIGS. 9 and 10. The ring 21 consists of a rectangular section made, for example, from the same material as the case 1, intended to fit tightly around the article 3 to be housed in the case 1, This ring 21 is mobile, preferably around a translation axis perpendicular to the parallel planes of the two large faces 4, 5 of the case 1. Thus, as shown in FIG. 10, the article 3 is inserted in this ring 21, which is ideally situated essentially at the middle of the case 1, and then placed against the top side 6 of the case 1.

The front face of the case 1 of the invention can also be fitted with a mobile lid, the rotation axis of which can follow either one of the small parallel sides 6′ or 6″ or the top side 6, next to the raised edge 13. Thus, in this case, the shoplifter cannot directly access the article 3 housed in the case 1 and cannot damage the packaging of the article or the case in order to remove the article 3.

It is obvious that the case 1 of the anti-theft device also comprises a theft-detection system, not shown, such as, for example, a contactless tag, applied against one of the faces of the case 1, fixed to the said case 1 by gluing, for example.

1-17. (canceled)

18. An anti-theft device for articles, comprising a rigid parallelepipedal case with two large faces and four sides, a first one of the large faces forming an opening for insertion of an article with dimensions that are essentially the same as those of the case, said first one face comprising a first raised edge that is an extension of one of the sides, wherein said device comprises:
a trigger member that can occupy a locked position, which is mobile in translation around an axis of a plane of the first face, said trigger member comprising at least one additional raised edge which cooperates with the first raised edge to prevent the removal of the article contained inside the case, and
a locking pull rod that is mobile around an axis that is transverse to movement of the trigger member and which can lock the trigger member in said locked position.

19. An anti-theft device according to claim 18, wherein the trigger member comprises at least one counterweight or a strip consisting of at least one magnet-sensitive element, that is able to interact with a magnetic field.

20. An anti-theft device according to claim 19, wherein said at least one magnet-sensitive element is formed from iron.

21. An anti-theft device according to claim 19, wherein the pull rod comprises at least one housing or orifice that is able to house or receive the at least one counterweight when the trigger member is in said locked position.

22. An anti-theft device according to claim 21, wherein the at least one counterweight has a top section that is essentially T-shaped so as to interact with a part of the housing or the orifice by detenting.

23. An anti-theft device according to claim 21, wherein said device further comprises at least one spring, located under the at least one counterweight in order to raise the at least one counterweight inside the housing or the orifice of the pull rod.

24. An anti-theft device according to claim 18, wherein at least one of the case, the trigger member and the pull rod is made from a plastic material.

25. An anti-theft device according to claim 24, wherein the plastic material is a polycarbonate.

26. An anti-theft device according to claim 18, wherein the trigger member comprises at least one mobile lateral wing, at least one part of which is housed in a housing of the case so that when the trigger member moves, said at least one part becomes trapped in the housing and defines the translation movement of the trigger member.

27. An anti-theft device according to claim 18, wherein the trigger member comprises a first orifice for a pushing end of the pull rod to pass through.

28. An anti-theft device according to claim 27, wherein the trigger member comprises a second orifice for another end of the pull rod to pass through when the trigger member is in said locked position.

29. An anti-theft device according to claim 18, wherein a second large face of the case comprises an orifice or an opening.

30. An anti-theft device according to claim 27, wherein the first orifice has a shape that is essentially identical to a shape of the pushing end of the pull rod.

31. An anti-theft device according to claim 28, wherein the second orifice has a shape that is essentially identical to a shape of the another end of the pull rod.

32. An anti-theft device according to claim 18, wherein the case is made at least partly from a transparent plastic material so that the article housed in the case can be seen.

33. An anti-theft device according to claim 18, wherein the trigger member comprises at least one spring that can push the pull rod back when unlocking the trigger member.

34. An anti-theft device according to claim 18, wherein the case comprises means for wedging the article.

35. An anti-theft device according to claim 34, wherein the said wedging means are removable and mobile.

36. An anti-theft device according to claim 18, wherein the case comprises a mobile ring that can fit tightly around the article housed in the case.

37. An anti-theft device according to claim 18, wherein the case comprises a lid.
